(19) United States
(12) Patent Application Publication
(10) Pub. No.: US 2011/0141432 A1
(43) Pub. Date: Jun. 16, 2011

(54) SUNGLASS LENS

(76) Inventor: Gary W. NESTY, Brazil, IN (US)

(21) Appl. No.: 12/968,946

(22) Filed: Dec. 15, 2010

Related U.S. Application Data
(60) Provisional application No. 61/284,228, filed on Dec. 15, 2009.

(51) Int. Cl. G02C 7/10

(52) U.S. Cl. 351/44

(57) ABSTRACT

A sunglass lens includes a lens body having a first and a second surface, a top edge, a bottom edge, a first side edge and a second side edge. The lens body also includes an upper portion disposed adjacent to the top side edge and a lower portion disposed adjacent to the bottom side edge. An aqua colored tint is applied to the lens body for highlighting an appearance of yellow colored objects to a user. A darkening tint is applied on the upper portion of the lens body for reducing the amount of light transmitted through the lens.

### PRIORITY STATEMENT

The instant application claims benefit of and priority to Gary W. Nesty U.S. provisional patent application No. 61/284,228 which was filed on 15 Dec. 2010, and which is fully incorporated herein by reference.

### I. TECHNICAL FIELD OF THE INVENTION

The present invention relates to lenses for eye glasses, and more particularly, to a sunglass lens that has a special utility in connection with racquet sports, such as tennis, or other sports where yellow playing balls are used such as lacrosse and softball.

### II. BACKGROUND OF THE INVENTION

For many years, sunglasses have been employed to reduce the intensity of light that reaches the eye of a user, and to make viewing and especially outdoor viewing on sunny days more comfortable for the user. Traditionally, sunglasses comprise eye glasses that employ lenses that are tinted to reduce the amount of light that passes through the lens. This reduction in light intensity reduces eye strain in bright circumstances, and saves the user from squinting when in brightly lit areas, such as the outdoors on bright sunny days.

Sunglasses are tinted a variety of colors. Some have a brownish tint, whereas others have a greenish tint or a grey tint. Other colors have also been used.

The choice of tint used is determined by the particular desires of the user and the characteristics of the light that is allowed to pass through the particular color of tint. For example, gray tinted lenses have the benefit of filtering all wave-lengths of color generally equally. As such, gray lenses are often preferred because they maintain the natural colors that the user is viewing, although the intensity (or brightness) of the colors is reduced. The intensity of color is reduced because the sunglasses absorb most wavelengths of light generally and equally reduce the intensity of the light entering the user's eyes. For some users, maintaining natural color is important; for example, it helps drivers distinguish between read and green traffic lights.

Lenses that are tinted in colors other than gray tend to have selective absorption characteristics which filter certain wavelengths of light to a greater degree than they filter other wavelengths. For example, amber glasses have a tint which alters the intensity of selected colors; amber lenses tend to filter out a greater percentage of blue light than red light, altering the intensity of the selected colors causing the blue tones to be less prominent and the red tones to be highlighted. Some users value the blue blocking propensities of amber glasses, because blue light, being at the edge of the visible spectrum, tends to cause more eye strain than other wavelengths of light, such as red light. However, the price to be paid for such amber tinted glasses is color distortion.

In certain circumstances, the colors of tint chosen for a sunglass lens are dictated by the user's desired activities. For example, in the Applicant's application. Ser. No. 12/082,475, that was filed on 11 Apr. 2008, that has since matured on 17 Aug. 2010 with U.S. Pat. No. 7,775,659 and that is fully incorporated herein by reference, a lens is disclosed that is especially useful for fishing activities. The lens disclosed in the Nesty '659 patent includes a darker green upper portion, and a lighter yellowish green lower portion. It has been found by the Applicant that the color combinations disclosed in the '659 patent are particularly advantageous to those fishing, because the particular choice not only reduces the glare from the water and sun, but also intensifies greenish colored fish that are swimming in the waters.

Another aspect of tinting relates to what is known as a gradient lens. In a gradient lens, the amount of tinting is not uniform throughout the entire area of the lens. Rather, the color and/or darkness of the lens varies from the top of the lens to the bottom.

In a typical gradient lens, the lens is tinted to be darker toward the top of the lens to absorb relatively more light, and lighter toward the bottom of the lens to absorb relatively less light. This type of gradient has value because the darker top portion of the lens tends to block out the greatest source of light and glare, which is usually the sun overhead, while providing a lens of lesser tint intensity in the lower portion of the lens. This allows more light to pass through the lower part of the lens, and therefore cause less interference in low light situations. As such, this typical type of gradient sunglass lens divides the lens into zones. The gradient tinted lens divides the lens into a relatively more glare or light blocking top portion of the lens; and a relatively more light transmissive the bottom portion of the lens.

In addition to fishermen favoring a greenish colored lens, participants in other activities favor different types of colors of lenses. For example, it has been found that aqua colored lenses have utility when used in connection with racquet sports such as tennis. Aqua colored lenses work well for tennis players because the aqua tint of the lens helps to intensify the tennis court boundary lines to make them more intense and easily visible to the players. Additionally, an aqua colored lens makes the yellow of the tennis ball appear brighter.

In summary, the use of an aqua tinted lens helps the tennis player to facilitate his game by increasing the intensity of, and hence, increasing the tennis player's perception and vision of a tennis ball and of boundary lines. It is believed by many tennis players that this enhanced ability of a player to see the tennis ball near the out of hounds lines when wearing aqua tinted glasses causes the aqua tinted glasses to give the user an edge in his or her performance.

Notwithstanding the ability of the aqua tinted glasses to perform their intended function, room for improvement exists. In particular, room for improvement exists as currently known aqua tinted sunglass lenses suffer the drawback of not being effective when the user looks up to catch a high shot such as a lob. The aqua colored sunglasses used presently tend not to be effective because they are not sufficiently effective in sufficiently blocking sun light that one normally encounters when looking up, resulting in eye strain and reduced visual acuity.

Therefore, one object of the present invention is to provide a pair of sunglass lenses, either polarized or non-polarized, that will overcome the aforementioned issue.

### V. SUMMARY OF THE INVENTION

In accordance with the present invention, a sunglass lens is provided that is especially useful in connection with racquet sports, and certain other sports. The sunglass lens preferably contains an aqua tint throughout its area. In addition to the aqua tint, the upper portion of the lens also includes a darkening tint that overlays and performs additively with the aqua tint to reduce the transmission of light through the lens to a degree greater than the aqua tint alone.

The darkening tint containing upper portion is preferably sufficiently dark enough so as to reduce eye strain of the user who is staring up above the horizon level. To accomplish the desired result, the darkening tint member is preferably in the form of a gradient tint, that is colored more darkly, closer to the upper edge of the darkening tinted portion, and hence, the upper part of the lens, and is less darkly colored, as one moves toward the bottom of the darker tinted portion.

In a most preferred embodiment, the darkening tinted portion extends over the entire upper portion, wherein the upper portion (and hence the darkening tint) extends over between about 20% and 50% of the finished, in-the-frame lens. More preferably, the darkened tint containing upper portion 56 extends over approximately over the upper 20 to 40 percent of the lens and most preferably over the upper 30% of the finished in-the-frame lens.

One configuration of the present invention is a lens that includes both an aqua tinted lower portion of the lens and a gradient darker tin, such as gray, overlaying the aqua tinting on the upper portion of the lens. This feature has the advantage of both highlighting the tennis court marking lines and brightening the intensity of the yellow tennis ball, while also being more effective at blocking out glare and reducing the intensity of the brightness of the sun in the sky when looking up, to thereby enable the user to better see and play high at lob shots.

These and other features of the present invention will become apparent to those skilled in the art, upon a review of the attached drawings and detailed description of the preferred embodiments of the present invention, exemplifying the best mode perceived presently by the Applicant of practicing the invention.

### IV. BRIEF DESCRIPTION OF THE DRAWINGS

FIG. 1 is a perspective, schematic view of a pair of sunglasses that embody the lens of the present invention;

FIG. 2 is a frontal view of a lens blank of the present invention;

FIG. 2A is a sectional, highly schematic view taken through lines 2A-2A of FIG. 2

FIG. 3 is a chart showing the light transmission characteristics of a function of wavelength through a first zone, (1) of the lens blank shown in FIG. 2;

FIG. 4 is a chart showing the transmission of light through the lens as a function of wavelength through a second zone (2) of the lens of the present invention;

FIG. 5 is a chart showing the transmission of light through the lens as a function of wavelength of a third zone (3), of the lens of the present invention;

FIG. 6 is a chart showing the transmission of light through the lens as a function of wavelength of a fourth zone (4) of the lens of the present invention; and

FIG. 7 is a chart showing the transmission of light through the lens as a function of wavelength of a fifth zone (5) of the lens of the present invention.

FIG. 8 is a schematic view of an alternate embodiment sunglass lens especially adapted for indoor use;

FIG. 9 is a schematic view of an another alternate embodiment sunglass lens especially adapted for outdoor use;

FIG. 10 is a schematic view of another alternate embodiment sunglass lens especially adapted for indoor use; and

FIG. 11 is a schematic view of another alternate embodiment sunglass lens especially adapted for outdoor use.

### V. DETAILED DESCRIPTION OF THE PREFERRED EMBODIMENT

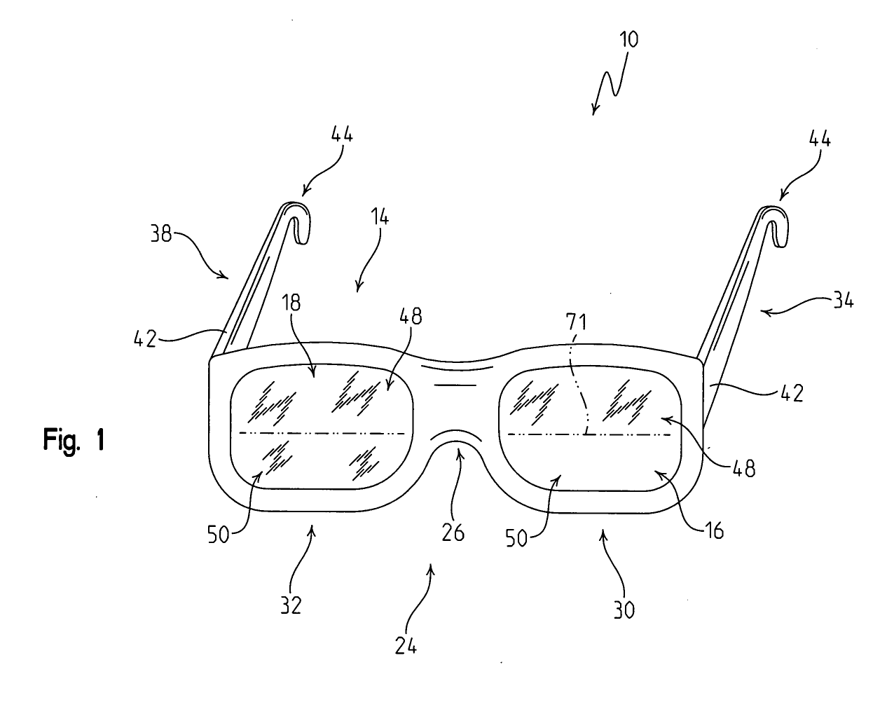

Turning now to FIG. 1, a pair of sunglasses 10 is schematically represented. The sunglasses 10 include a frame 14, that can be made out of metal, plastic or one of a variety of other materials. The frame includes a first, or left lens 16 that is made of a transparent glass or plastic material, and a second or right lens 18 that is also made from a glass or plastic material. Although lenses can be made from glass, most lenses today are made from some form of plastic material, including polycarbonate, which has good optical and refractive properties.

Some lenses are non-corrective lenses with the anterior and posterior curvatures of the lenses designed to provide little or no refractive properties. Other lenses, however, are corrective lenses. Polycarbonate is a lens material that has a relatively high index of refraction and a superior degree of impact resistance making it an excellent choice for active sport sunglasses for either prescription or non-prescription wear. Polycarbonate has a relatively high index of refraction that enables a corrective lens to be formed, that is capable of providing a high degree of refraction, and have a high degree of correction through a relatively thin lenses. This high refractive index enables persons with bad vision, that requires significant refraction, to correct this vision to “normal”, and to accomplish this correction with relatively thin glasses. As such, the higher refractive index of polycarbonate can spare the user from being condemned to wear thick “Coke bottle” type glasses.

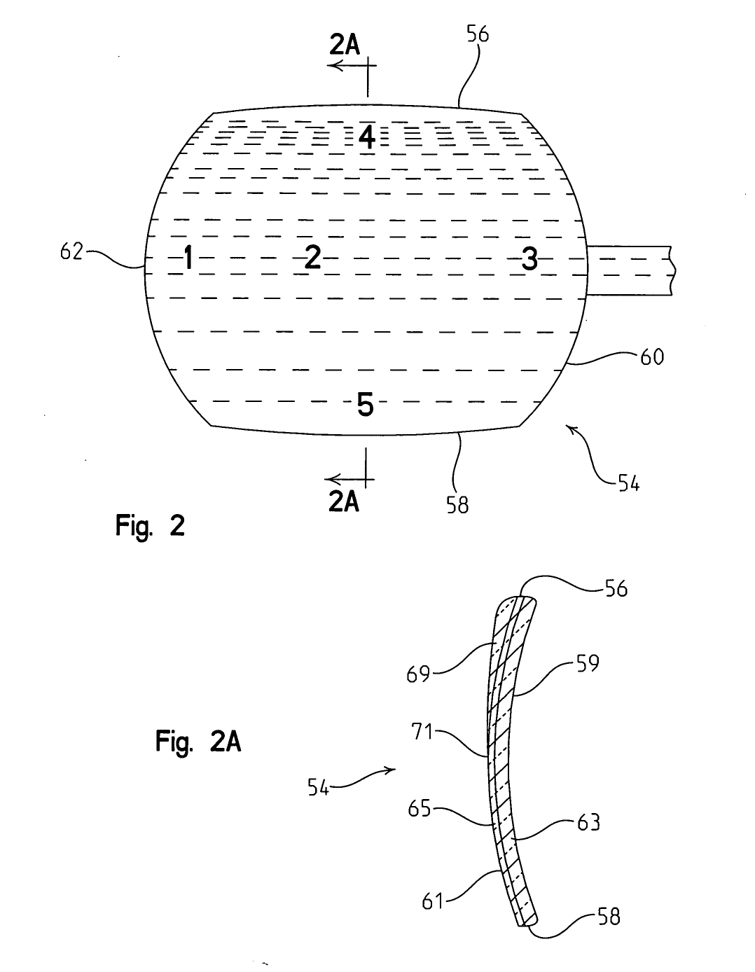

Each of the lenses 16, 18 include an upper portion 48, and a lower portion 50. As will be described in connection with FIG. 2, the upper portion 48 is generally less light transmissive, than the lower portions 50. The upper portions 48 is less transmissive, to more effectively reduce the intensity of the most likely source of high intensity light block out the normally greater energy to the user's eyes, with such most intense light source being the sun.

The frame 14 includes a front piece member 24 that includes a central, nose engaging portion 26. The front piece member 24 also includes a first lens receiving portion 30 and a second lens receiving portion 32. The first and second lens receiving portions 30, 32 comprise ring-like members having a radially inwardly facing perimetral surface that are provided for engaging the radially outwardly facing surfaces of the lenses 16, 18.

The first 34 (left) temple and a second 38 (right) temple are hingedly coupled to the front piece member 24. Each of the first and second temples 34, 38 includes a first end 42 that includes a hinge for hingedly coupling the first and second temples 34, 38 respectively to the front piece 24.

Each of the first and second temples 34, 38 also includes a second, ear engaging end 44. Although ear engaging ends 44 come in a wide variety of shapes and curvatures, many ear engaging ends 44 are shaped similarly to those shown in FIG. 1, that include rearwardly disposed hooks, for hooking around the back side of the user's ear. In addition to the hooks, frictional engagement between the first and second temples 34, 38 and the side of the user's head also helps to maintain the glasses on the user's head.

Turning now to FIG. 2, a lens blank 54 of the present invention is shown. The lens blank 54 comprises a lens that, while treated with the appropriate tinting, has not yet been cut and trimmed into a shape that will allow it to be inserted into a frame, such as frame 14. In order to create the lenses 50, 52 shown in FIG. 1, one starts with a lens blank 54, such as is shown in FIG. 2. This lens blank 54 is then tinted to the appropriate shade through a tinting process. The lens blank 54 is then cut, so that it will fit into the appropriate lens receiving portion of the frame.

A lens blank 56 such as blank 54 is used, because it has been found by the Applicant (and others), that the use of a lens blank reduces inventory costs.

Different sets of glasses have different sizes and shapes of lens receiving rings. The number of different shapes and sizes is limited only by the number of various glasses' ring sizes and designs. As such, it would be rather difficult and very expensive for most optical laboratories to include enough lenses in inventory to be able to have every lense to fill every frame that thereby enable the optical lab place a lens directly within a set of frames. Rather, lenses are first formed as lens blanks 54. A lens blank 54 can then be cut and shaped, to match the cut, size and shape of the frame aperture (ring) into which the finished lens is to be placed.

Because different users require no prescription or varying amounts of refractive correction, no one blank will likely be able to perform appropriately for all users and frames. However, a relatively small number of different blanks, can be finished or provide lenses that fit a wide variety of frames and connective requirements.

As best shown in FIG. 2, lens blank 54 includes an upper edge 56, a lower edge 58, a first side edge 60 and a second side edge 62. The upper side 56 is closer to the upper portion 48 of the lens, and the lower side 58 is closer to the lower portion 50.

It will be noted that the lens blank 54 is drawn as being more heavily shaded, this indicating that the lens is more heavily tinted and hence significantly less light transmissive in the upper portion 48 than it is in the lower portion 50. It will also be noted that the degree of light transmitiveness of the lens increases as one moves from the upper edge 56 of the lens blank 54, toward the middle of the lens blank, 54 indicates that the tinting dye has been applied to the lens in a gradient manner so that the tinting coating causes the lens to be less light transmissive adjacent to the top edge 56 of the lens, and more light transmissive adjacent to the demarcation line 71 that marks the lower most extent of the application of the darkening gray dye.

In order to form a lens blank 54 of the present invention, a lens blank 54 is employed to which an aqua tint is applied over the entire lens surface from the top edge 56 to the bottom edge 58, and in between the first edge 60 and the second side edge.

The aqua color that is applied to the entire lens blank can either be applied by a dying process, wherein the lens is dipped in an appropriate dye, or a film process. In a film process, a film of the appropriate color is attached to one of the inner or outer surfaces of the lens. Preferably the aqua tint is applied in a uniform manner to the lens so that the percentage of light transmitted through the aqua coating is between about 20% to 40% for “outdoor” glasses, and between about 40% and 60% for indoor glasses.

As will be described in more detail below, the sunglasses of the present invention can be designed if desired, to maximize effectiveness for either indoor play or outdoor play. Since the light is usually more intense outdoors, those lenses designed for outdoor play are designed to be less light transmissive than those glasses designed for outdoor play. As best shown in FIG. 2A, the finished lens 54 has an inwardly (toward the eye) facing surface 59, and an outwardly (away from the eye) facing surface 61.

The lens 56 includes a generally clear glass or plastic body 63 which is shown schematically in FIG. 2A as being of uniform thickness from its top edge 56 to its bottom edge 58, to indicate that the lens 54 is not a corrective lens. In contrast, a corrective lens (not shown) would probably have a varying thickness between its top 56 and bottom 58 edges. The layer of aqua tint 65 is applied to either or both of the inner 59 or outer surface of the clear blank, or dyed into the entire lens thickness 63.

Although the thickness of the layer of aqua tint 65 is not shown to scale in FIG. 2A (vis-a-vis the thickness of clear blank 63) it will be noted nonetheless that the aqua tint 65 layer or dye is referenced having a uniform thickness or density to achieve a uniform degree of light transmission between the top 56 and bottom 58 edge of the lens blank 58

A darkening tint (often a gray dye) is then applied to the upper portion of the lens, and preferably, to about the upper 20% to 50% of the finished in-the-frame lens. Most preferably, the darkening tint is applied to an area comprising the upper portion 30 percent of the area of the finished in-the-frame lens, so that the gray dye extends from the top surface 48 approximately 30% of the way downwardly, toward the bottom surface 50.

In order to apply the gray dye, a gradient application process is employed. To get the gradient effect, the lens 54 is dipped into a vat of coloring materials (upside down) so that the bottom 58 of the finished lens is actually disposed above the surface of the coloring material. Preferably, approximately 30% to 50% of the area of the lens, closest to the top surface 56 is the only portion of the lens that is placed into the coloring solution.

At the beginning of the cycle, this upper 30% to 50% of the lens can be held by a fixture so that it is submerged into the dye solution. Over time, the fixture that holds the lens 54 in the tank, raises the lens 54 out of the dye solution. This process causes the top of the finished lens 56 (that, as described above, is positioned closer to the bottom of the dye vat) to remain in the dye for a longer period of time than the bottom of the dyed portion of the finished lens. As only 30% to 50% of the surface area of the lens 54 is dipped into the dye vat, the bottom 50% to 70% (approximately) will spend very little to no time within the dyed materials.

By remaining submerged in the dye for a longer period of time, the upper most portion of the lens 54 can absorb more dye and hence, turn into a darker color turning now to FIG. 2A, it will be noted that the darker tinted layer 69 is shown as being thicker or denser towards the top edge 56 than it is adjacent to the line 71 that represents the lower edge of the gray tinted layer 69. The gray layer is thicker or denser at the top because it has remained in the dying vat for a period of time longer that the portion of the lens adjacent to the lower extent line 71.

This enhancement of the gray area 69 near the top edge means that the darker tint will allow less light to be transmitted through the lens in the upper lens portion adjacent upper edge 56, and more light to be transmitted through the lens 54 adjacent to line 71, the thickness or density of the darker tint preferably decreases to zero. For example, near edge 56, the gray tint preferably allows only about 4% to 10% of light to be transmitted for a lens 54 designed for outdoor play, whereas adjacent to line 71, the gray tint preferably allows about 90% to 100% of light to pass through, as the gray tint transitions from being present to non existent. Most preferably, the top edge of the darker tint 71 layer allows about 6% of light to be transmitted there through.

Unlike the gradient darker tint, the aqua tinting is generally constant in light transmittance throughout the full extent of lens 54. For outdoor use lenses, the applicants have found that the aqua lens tint 65 should permit between about 15% and 45% of the light to be transmitted through just the aqua tint and preferably between about 20% and 40% of the light to pass through.

Lenses that are intended for indoor use are tinted to be more light transmittive than the outdoor lenses described above. For example, the lowest transmission percentage for the darker tinted portion of the lens for indoor use may be between about 30% and 40% at the upper most edge of the lens and decrease in density to zero at the middle portion of the lens at which point the aqua tint becomes the prominent tint. Similarly, the aqua tint for an indoor lens should be between about 40% and 70% light transmittive and preferably between 50% and 60% light transmittance throughout the entire area of the lens 54 designed for indoor use.

Interestingly, it has been found by the applicant that the addition of the aqua tint to highlight the ball and court marking lines, and the ability of the darker tint to reduce glare from overhead light, improves the users ability to see the ball and lines to a greater extent than the concurrent reduction in light transmittance reduces the users ability to see the ball and lines.

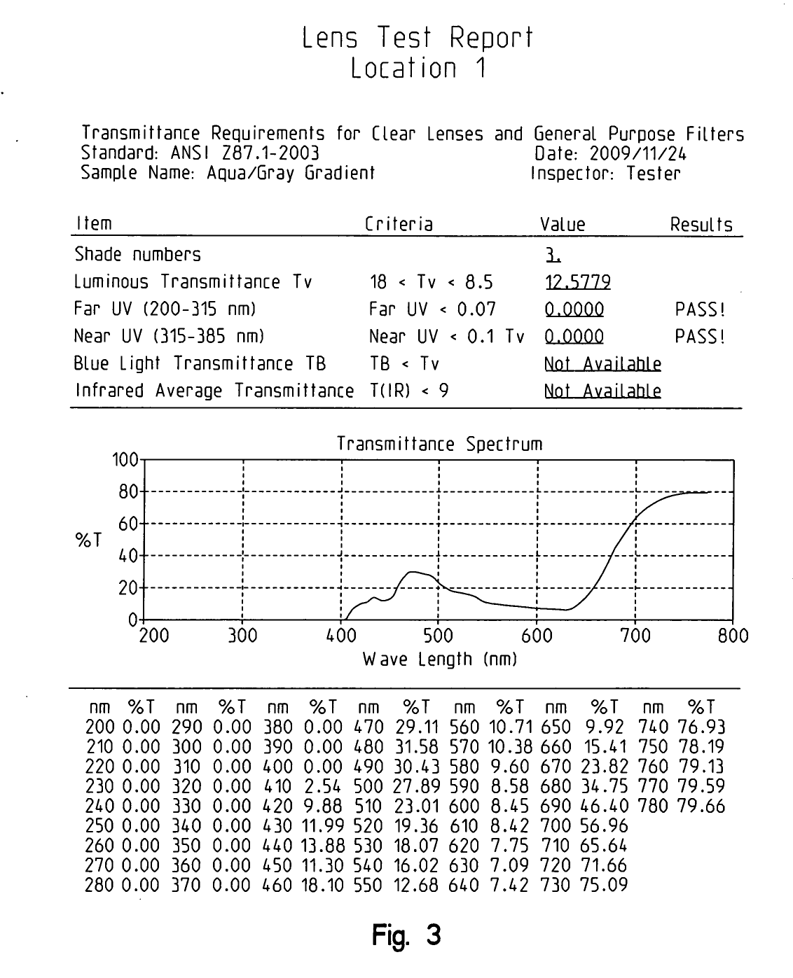

The varying transmittance of different portions of the lens (shown in FIG. 2) is best described below with reference to FIGS. 3-8. In FIG. 2, there are shown five (5) zones, including Zone L1, Zone L2, Zone L3, Zone L4 and Zone L5. Zones L1, L2 and L3 are intermediate in the lens between the top 56 and the bottom 58 of the lens blank 54. In the finished lens, Zones L1, L2 and L3 will be appropriately between about 25% and 40% of the way from the top edge 56 to the bottom edge 58, so that they are disposed closer to the top portion of the finished lens.

Zone L1 is disposed adjacent to the second side. Zone L2 is disposed generally in the center of the finished lens (viewed side to side), and Zone L3 is closer to the first side 60. Zone L4 is disposed close to the top of the lens, and Zone L5 is disposed at the center of the lens, close to the bottom surface 58. From the discussion above, it will be appreciated that the lens is darkest (least light transmittance) in Zone L4, is of intermediate darkness (intermediately light transmittance) in Zones L1, L2 and L3 and is at its lightest (most light transmittance) at Zone L5.

Because the darker dye, in this case gray, is applied in a gradient application process, Zone L4 will have the greatest concentration of darker dye, making it generally the least transmittive to all light in general. In contrast, as the darker dye is applied to a lesser degree to the intermediate areas of Zone L1, L2 and L3, the intermediate portion of the lens is relatively more transmittive to the passage of light that in Zone L4, but relatively less transmittive to the passage of light than in Zone L5. It will also be appreciated that Zone L5 comprises an aqua only tinted portion of the lens, whereas as Zone L4 in particular, and Zones L1, L2 and L3 have a color that is influenced by both the aqua tint and the darker tint, in this case gray.

As best shown in FIG. 2 there are five locations, L1-L5 chosen in the lens blank 54. The significance of these locations is that these locations correspond with the lens test reports shown in FIGS. 3-7. These lens test reports help to identify the color and transmittance of the various locations of the lens, and thus helps describe the lens, with reference to its color and transmittive values.

Turning now to location L1, it will be noted that it is generally in the middle of a lens blank 54 (top to bottom), and is adjacent to the second side 62 of the lens blank 54. Position L1 is a position that is generally at the bottom of the gradient dyed darker area in the upper portion of the lens blank 54. Turning now to the lens' test report, it will be noted, in the case of gray as the darker gradient tinted portion of the lens, that the luminous transmittance Tv has a value of 12.5779. This value is greater than the Tv volume at position L4 (2.1745) at the extreme, heaviest least light transmittive portion of the gray gradient, and is lower than the luminous transmittance value of position L5 (27.0383), that is generally devoid of gray gradient.

This luminous transmittance value therefore tends to suggest that at location L1, more light is blocked by the lens 54, than would occur, at position L5. Similarly, this transmittance value of 12.5779 at position L1 suggests that the lens is not as dark, and allows more light to pass through, than at position L4, (TV=2.1745) that is in the heart of the deepest part of the gray gradient coated area.

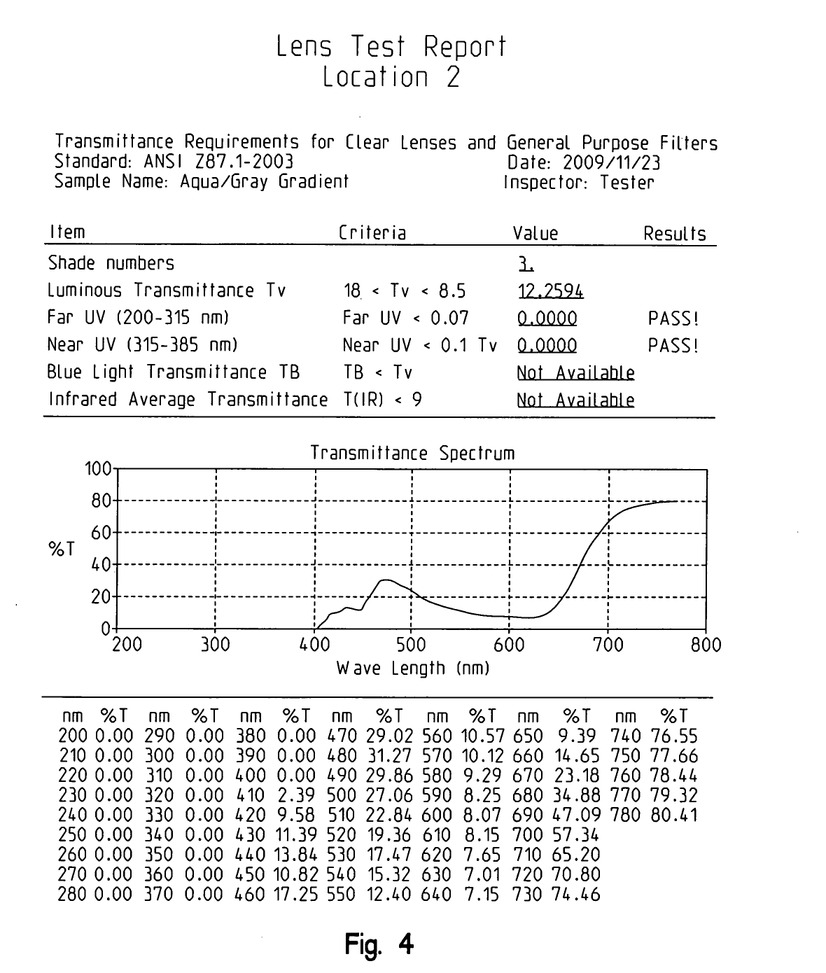

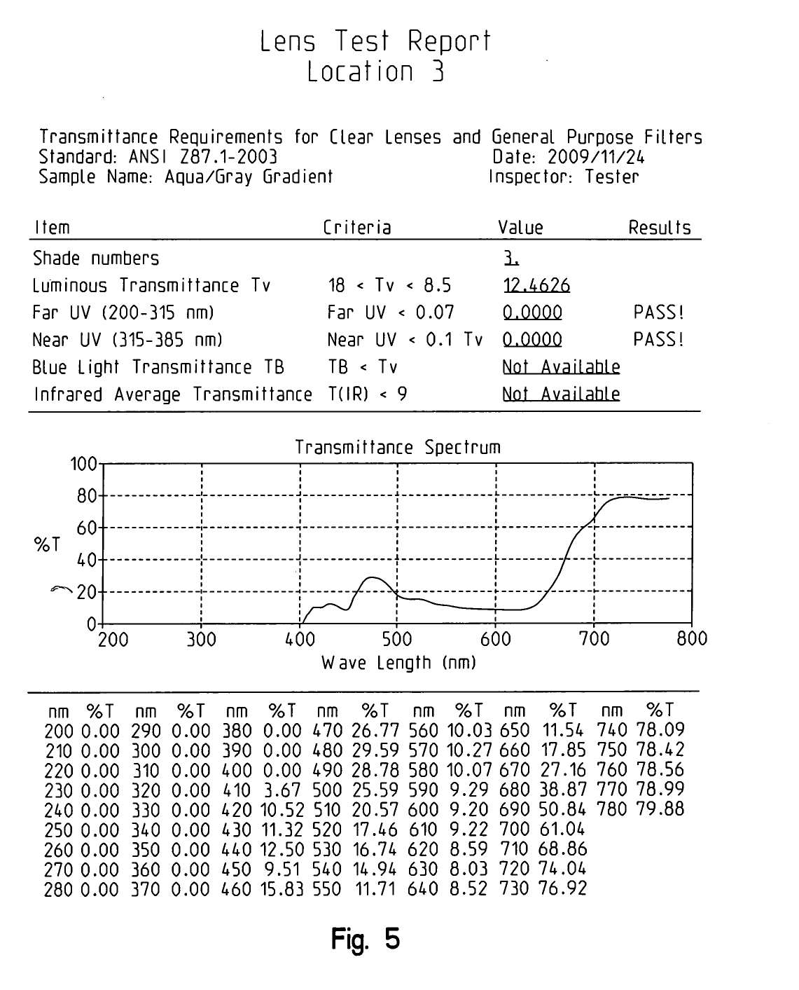

Turning now to FIGS. 4 and 5, it will be noted that the luminous transmittance value at positions L2 and L3 is generally similar to the luminous transmittance value at L1. This is to be expected, as the transmittance of the lens blank 54 increases and decreases as one moves vertically up and down the lens, whereas, the transmittance does not change significantly as one moves between the left and right side, at a particular vertical location.

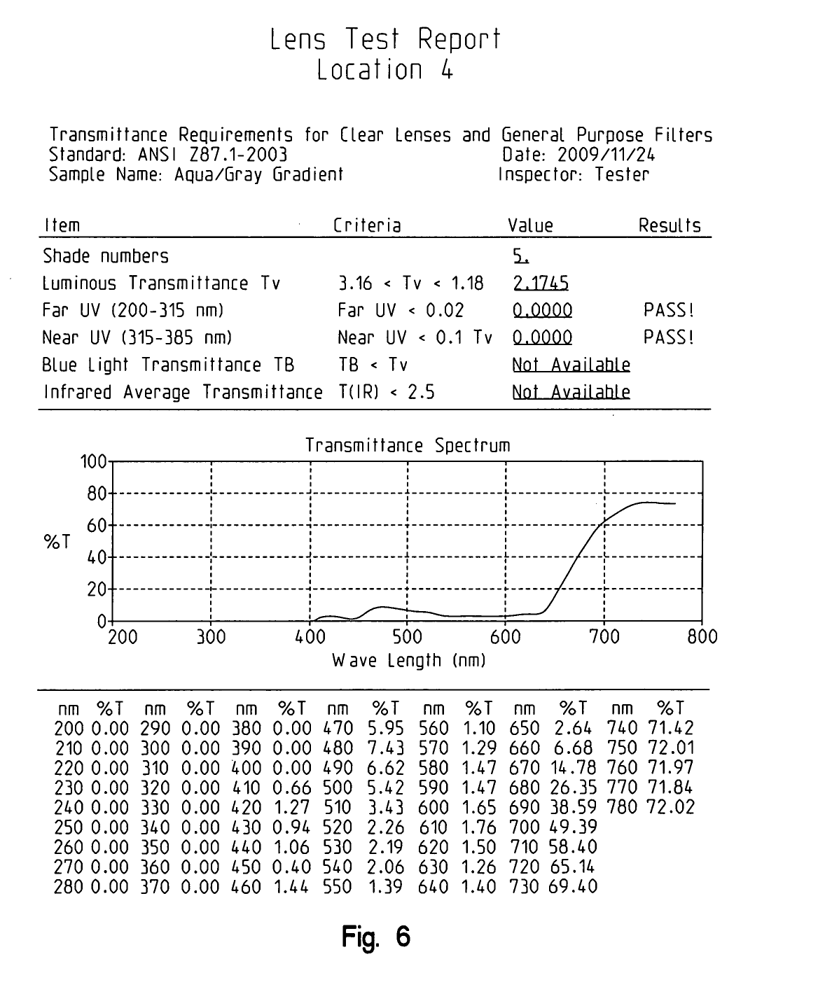

As shown in FIG. 6, the luminous transmittance value at location L4 is 2.1745, which is significantly less than the 12.x (e.g. 12.5779) transmittance value of locations 1, 2 and 3. This low luminous transmittance value at location L4 confirms that which has been discussed earlier. In particular, it confirms, that the lens 54 allows less light to pass therethrough near the top 56 of the lens 54, to better block out the glare and higher quantity of light than one would expect from the sun, which is likely to be above the user.

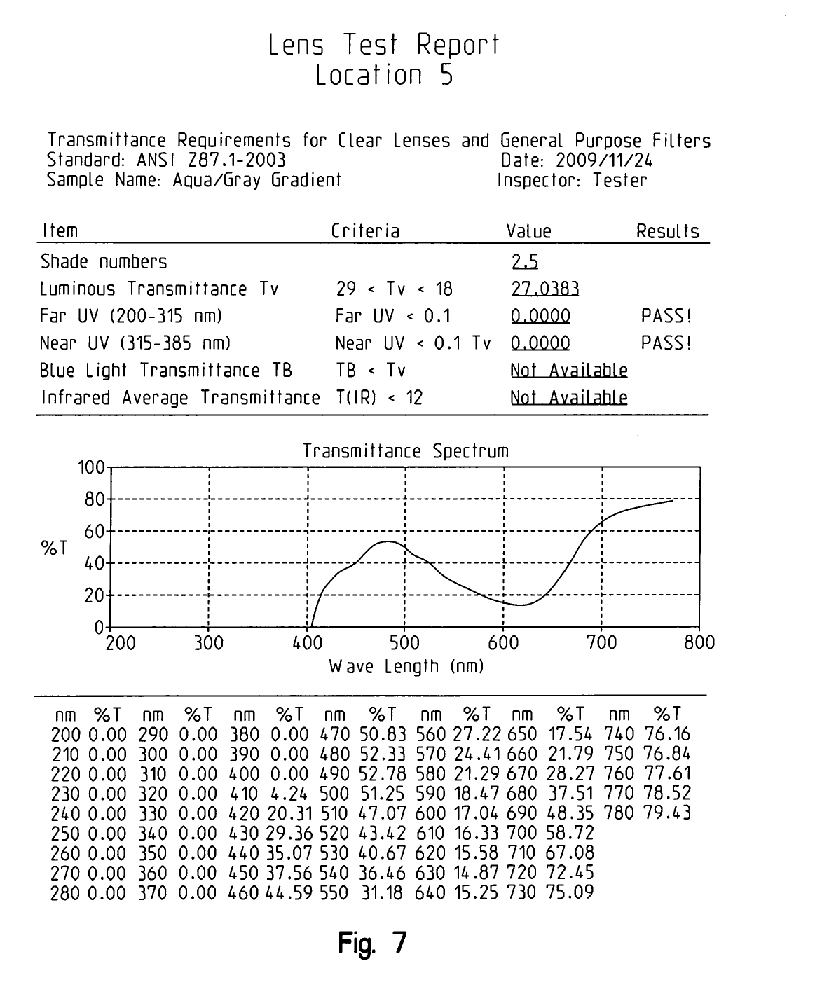

In FIG. 7 the luminous transmittance value at position L5 is 27.0383, which is significantly higher than in either positions L1, L2, L3 in the middle of the lens; or position L4 near the top of the lens. This luminous transmittance suggests that the bottom of the lens allows a greater amount of light to pass through.

These values are also confirmed by the shade numbers. It will be noted that the shade numbers have a value of 3 at positions L1, L2, and L3; a shade number of 5 at position L4 and a shade number of 2.5 at position L5.

The transmittance spectrum at position L1 (the middle of the lens) suggests that very little to no transmittance occurs in the 200 to 400 nm range, that generally comprises the UV portion of the spectrum, and the beginning of the visible violet portion of the spectrum. The transmittance increases to approximately 12 percent at about 430 nm (violet), and achieves a first peak at around 470-490 nm, that is in the blue portion of the spectrum. The percentage transmittance falls off between 490 nm and 640 nm, that comprises the green, yellow and orange portion of the spectrum. The transmittance then increases beginning at about 650 nm, up through about 780 nm, that suggests that transmittance increases significantly in the red and infra-red portion of the spectrum.

Turning now to FIGS. 4 and 5, it will be noted that the transmittance spectrum is generally similar for positions L1, L2 and L3, as it is at position L1.

However, a significantly different transmittance spectrum exists in position L4, near the top of the lens. At position L4, it will be noted that the transmittance percentage is at or near zero in the ultraviolet and the close-to-ultra violet visible violet portions of the spectrum (approximately 200 nm to 460 nm). The transmittance percentage also is generally less than about seven percent through the 460 nm to 660 nm range of the spectrum. The transmittance value does not rise above 14 percent until the red portion of the spectrum (approximately 670 nm), and then increases to about 70% in the infrared portion of the spectrum (750 nm to 780 nm).

FIG. 7 shows a transmittance spectrum for location L5, that is very different than the transmittance spectrum for location L4, or even for that matter, locations L1, L2 and L3. The transmittance spectrum for location L5 shares a similarity with the other transmittance spectrums, as it shows that very little to no transmittance that exists in the ultraviolet range. However, significantly greater transmittance than at any other location exists in the indigo and blue range (420 nm-530 nm). There is a significant drop off in the 590 nm-660 nm range and then transmittance picks up as one increases into the 670 nm-780 nm range. The transmittance values help to define the aqua tint used in the lens as being a tint that has a first peak transmittance range between about 450 nm and 540 nm, and more precisely, between about 470 nm and 510 nm; and a second peak transmittance range of between about 670 nm and 780 nm, and more precisely between about 710 nm and 780 nm.

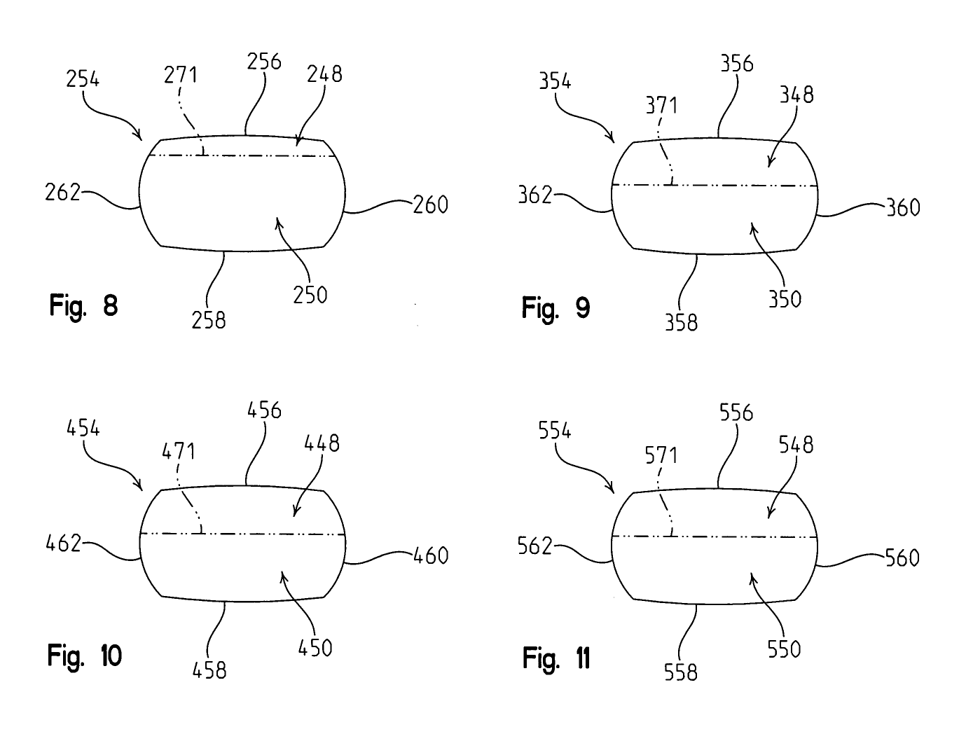

Turning now to FIGS. 8-11, various embodiments are represented schematically. FIG. 8 illustrates an indoor sunglass lens 254 of the present invention. The lens 254 includes a top edge 256, a bottom edge 258, a first side edge 260, and a second side edge 262. The lens 254 also includes an upper portion 248 that includes a darkening tint (such as a gray tint) along with an aqua colored tint. The demarcation line 271 marks the furthest lower extent of the darkening tint (and hence upper portion 248), with the lower portion 250 comprising an area of the lens that receives only the aqua tint.

It will be noted that the darkening tint only extends a short way down the lens to only cover a small area of the lens 254 near the top edge 256 of the lens. The smaller darkened upper portion, wherein the demarcation line 271 may be placed 15% to 40% of the distance from the top edge 256 to the bottom edge 258 causes less darkening of the image seen by the user through the lens, which lessened light blockage (and hence greater light transmittance) functions well under the relatively lower light, less glare conditions that one typically encounters in indoor facilities.

FIG. 9 illustrates an outdoor sunglass lens 354 of the present invention. The lens 354 includes a top edge 356, a bottom edge 358, a first side edge 360 and a second side edge 362. The lens 354 also includes an upper portion 348 that includes a darkening tint (such as a gray tint) along with an aqua colored tint. The demarcation line 371 marks the furthest lower extent of the darkening tint (and hence upper portion 348), with the lower portion 350 comprising an area of the lens that receives only the aqua tint.

It will be noted that the darkening tint may be a significantly greater way down the lens 354 to only cover a relatively larger area of the lens 354, when compared to the upper portion 248 of the indoor lens 254. The larger darkened upper portion, wherein the demarcation line 371 may be placed 20 to 50 percent of the distance from the top edge 356 to the bottom edge 358 causes a greater degree of darkening of the image seen by the user through the lens, which increased light blockage (and hence lesser light transmittance) functions well under the relatively greater light, greater glare conditions that one typically encounters in outdoor facilities.

FIG. 10 illustrates an indoor sunglass lens 454 of the present invention. The lens 454 includes a top edge 456, a bottom edge 458, a first side edge 460 and a second side edge 462. The lens 454 also includes an upper portion 448 that includes a darkening tint (such as a gray tint) along with an aqua colored tint. The demarcation line 471 marks the furthest lower extent of the darkening tint (and hence upper portion 448), with the lower portion 450 comprising an area of the lens that receives only the aqua tint.

It will be noted that the darkening tint extends about 30% of the distance between the top 456 edge and the bottom 458 edge, which is similar to the distance at which the demarcation line 371 of the outdoor lens 358 of FIG. 9 is placed. The upper portion 448 is specially adapted for use with an indoor lens by the darkening tint being placed less thickly on the lens to provide a greater amount of light transmittance than with an outdoor lens. In the indoor lens, the least light transmittive portion of the gray tint should have a transmittance of greater than 6 percent, and preferably at between about 30 percent and 40 percent, with the grey tint becoming more light transmittive as one moves from the top edge 456 to the demarcation line 471. This greater light transmittance of the gray tint causes less darkening of the image seen by the user through the lens, which lessened light blockage (and hence greater light transmittance) functions well under the relatively lower light, less glare conditions that one typically encounters in indoor facilities.

FIG. 11 illustrates an outdoor sunglass lens 554 of the present invention. The lens 554 includes a top edge 556, a bottom edge 558, a first side edge 560 and a second side edge 562. The lens 554 also includes an upper portion 548 that includes a darkening tint (such as a gray tint) along with an aqua colored tint. The demarcation line 571 marks the furthest lower extent of the darkening tint (and hence upper portion 548), with the lower portion 550 comprising an area of the lens that includes only the aqua tint.

It will be noted that the darkening tint extends about 30% of the distance between the top 456 edge and the bottom 458 edge, which is similar to the distance at which the demarcation line 471 of the indoor lens 458 of FIG. 10 is placed. The upper portion 548 is specially adapted for use with an outdoor lens by the darkening tint being placed relatively more thickly or densely on the lens (compared to indoor lens 454) to provide a lesser amount of light transmittance than with an indoor lens.

In the outdoor lens, the least light transmittive portion of the gray tint should have a transmittance of between about 5 and 10 percent, and preferably about 6 percent, and, with the grey tint becoming more light transmittance as one moves from the top edge 556 to the demarcation line 571. This relatively lesser light transmittance of the gray tint causes relatively darkening of the image seen by the user through the lens 554, which greater light blockage (and hence lesser light transmittance.) functions well under the relatively more intense light, greater glare conditions that one typically encounters in outdoor venues such as outdoor tennis courts.

Having described the invention with reference to certain preferred embodiments, it will be appreciated that variations and modifications exist within the scope and spirit of the present invention.

What is claimed is:

1. A sunglass lens comprising a lens body having a first and a second surface, a top edge, a bottom edge, a first side edge and a second side edge, and an upper portion disposed adjacent to the top side edge and a lower portion disposed adjacent to the bottom side edge, an aqua colored tint applied to the lens body for highlighting an appearance of yellow colored objects to a user, and a darkening tint applied on the upper portion of the lens body for reducing the amount of light transmitted through the lens.

2. The sunglass lens of claim 1 wherein the darker tint comprises a color neutral darkening tint for reducing the amount of light transmitted through the lens without substantially altering colors of objects viewed through the lens.

3. The sunglass lens of claim 2 wherein the darkening tint is applied in a gradient manner so that the lens is relatively less light transmittive adjacent to the top edge, and relatively more light transmittive adjacent to the lower portion, and wherein the darkening tint extends from the top edge downwardly to between about 20% and 50% of the distance to the bottom edge.

4. The sunglass lens of claim 3 wherein the darkening tint extends from the top edge downwardly to between about 25% and 35% of the distance to the bottom edge.

5. The sunglass lens of claim 3 where the sunglass lens wherein the darkening tint extends throughout the upper portion, and wherein the darkening tint has a light transmittance of between about 4% and 10% adjacent to the top edge and between about 90% and 100% adjacent to the lower portion.

6. The sunglass lens of claim 5 wherein the lower portion includes substantially no darkening tint.

7. The glass lens of claim 3 wherein the sunglass lens comprises a sunglass lens especially adapted for indoor use, and wherein the darkening tint exhibits a light transmittance of between about 20% and 40% adjacent to the top edge portion and a light transmittance of between about 90% to 100% adjacent to the lower portion.

8. The sunglass lens of claim 7 wherein the darkening tint has a minimum light transmittance of between about 25% and 35%.

9. The sunglass lens of claim 7 wherein the aqua tint has a light transmittance of between about 50% and 60%.

10. The sunglass lens of claim 7 wherein the a aqua tint has a first peak wavelength range of transmittance of between about 450 nm and 540 nm and a second peak wavelength range of transmittance of between about 670 nm and 780 nm

11. The sunglass lens of claim 7 wherein the aqua tint has a first peak wavelength rage of transmittance of between about 470 nm and 510 nm, and a second peak wavelength range of transmittance of between about 710 nm and 780 nm.

12. The sunglass lens of claim 1 wherein the darkening tint is applied in a gradient manner so that the lens is relatively less light transmissive adjacent to the lower portion and wherein the darkening tint extends from the top edge downwardly to between about 20% and 50% of the distance to the bottom edge.

13. The sunglass lens of claim 1 wherein the darkening tint extends from the top edge downwardly to between about 25% and 35% of the distance to the bottom edge, and wherein the lower portion includes substantially no darkening tint.

14. The sunglass lens of claim 1 wherein the darkening tint comprises a gradient darkening tint having a light transmittance of between about 4% to 10% adjacent to the top edge, and wherein the lower portion has a light transmittance of between about 15% and 45%.

15. The sunglass lens of claim 1 wherein the sunglass lens comprises a sunglass lens especially adapted to indoor use, and wherein the darkening tint has a minimum transmittance of between about 20% and 40%.

16. The sunglass lens of claim 15 wherein the darkening tint has a maximum transmittance of between about 90% and 100%.

17. The sunglass lens of claim 15 wherein the aqua tint has a transmittance of between about 40% and 70%.

18. The sunglass lens of claim 1 wherein the sunglass lens comprises a sunglass lens especially adapted for indoor use, and wherein the aqua tint has a light transmittance of between about 40% and 70%.

19. The sunglass lens of claim 1 wherein the sunglass lens comprises a sunglass lens especially adapted for indoor use, and wherein the aqua tint has a light transmittance of between about 50% and 60%.

20. The sunglass lens of claim 1 wherein the aqua tint has a first peak wavelength range of transmittance of between about 450 nm and 540 nm, and a second peak wavelength range of transmittance of between about 670 nm and 780 nm.

21. The sunglass lens of claim 1 wherein the darkening tint comprises a color neutral darkening applied in a gradient manner for reducing the amount of light transmitted through the glass lens without substantially altering colors of objects viewed through the lens, and wherein the aqua tint has a first peak wavelength range of transmittance of between about 470 nm and 510 nm, and a second peak wavelength range of transmittance of between about 710 nm and 780 nm.
